(19) United States
(12) Patent Application Publication
(10) Pub. No.: US 2022/0249932 A1
(43) Pub. Date: Aug. 11, 2022

(54) SKI INSTRUCTION METHOD

(71) Applicant: Justin Frank Morrison Hollenbeck, Breckenridge, CO (US)

(72) Inventor: Justin Frank Morrison Hollenbeck, Breckenridge, CO (US)

(21) Appl. No.: 17/168,739

(22) Filed: Feb. 5, 2021

(51) Int. Cl. A63B 69/18

(52) U.S. Cl. CPC A63B 69/18; B62B 13/04

(57) ABSTRACT

The present disclosure is directed to a ski instruction method including the use of a stabilizing assembly during the instruction. The stabilizing assembly may include a balance bike that may provide stability to a student skier during the ski instruction process. In some embodiments, the student skier may be in a seated position on the balance bike, while in other embodiments the student skier may be in a standing position while straddling the balance bike. During the ski instruction method, the balance bike's rear ski is used to demonstrate the fundamentals of edge movements, rotary movements, and/or pressure movements.

### FIELD OF INVENTION

The invention relates to ski instruction, including ski instruction using a stability assembly.

### BACKGROUND

The movements required to effectively ski down a ski slope are generally unfamiliar and unnatural to the beginner skier, and because of this, the muscles associated with driving the movements of skiing are often weak and uncoordinated in student skiers. Aware of their physical limitations and the potential of injury due to falling, many beginner skiers, particularly beginner adult skiers, quickly develop emotional limitations, such as fear and stress. These emotions oftentimes disrupt the skier's learning experience and, in many cases, may lead to the student skier quitting the sport altogether. Furthermore, some potential skiers simply avoid learning how to ski for these same reasons. This results in millions of dollars of lost revenue to the ski industry every year.

Accordingly, there exists a need for a ski instruction method that minimizes the emotional and physical barriers associated with learning how to ski.

### BACKGROUND OF PRIOR ART

Several devices with corresponding methods of use have been developed to assist a skier in controlling their speed, controlling their direction, and/or supporting their weight during the ski learning/teaching process. For example, U.S. Pat. No. 5,397,154 to Baldwin discloses a stabilizing device comprising two skis (left and right) configured with a U-shaped frame within which the student skier stands. However, because the student is confined within the U-shaped frame and between the left and right skis, the device and its method of use inadequately restricts the movement of the skier.

In another example, U.S. Patent Application No. 2002/0011727 to Kernan discloses a handheld ski rocker that extends forward from the skier. However, while the rocker and its method of use may somewhat assist in teaching the skier to turn, it cannot be configured to support any of the skier's weight.

In another example, U.S. Pat. No. 5,120,227 to Born discloses a ski training device comprising a single ski configured with an upright post and a left and right handle. The student skier grips one handle, and the instructor grips the other. However, while the device and method of its use may provide limited vertical support to the student skier, is cannot be configured to provide freedom of operation to the student alone.

Other devices have been developed to support a skier during the learning process, such as for example, U.S. Pat. Nos. 5,397,154, 5,601,434, and 6,746,248 which aim to support the student via a supportive snow-sliding device, a suspension harness, or a body brace, respectively. However, none of these devices provide adequate support to the student skier without overly limiting his/her movements.

### SUMMARY

According to one aspect, one or more embodiments are provided below for a method of ski instruction. The method may utilize a balance bike equipped with a frame, at least one front ski, at least one rear ski, and a seat, and may comprise the steps of providing a balance bike to a student skier, securing a left ski to a left foot of the student skier and a right ski to a right foot of the student skier, instructing the student skier to sit on the seat and straddle the frame, instructing the student skier to balance themselves on the balance bike, demonstrating to the student skier how the rear ski is used to cause the balance bike to turn through edging movements and/or rotary movements, instructing the student skier to move in a forward direction while sitting on the seat and straddling the frame, instructing the student skier to use the handlebars to change a direction of movement of the balance bike, instructing the student skier to slow down the speed of the balance bike by pressing a rear edge of the left and/or right skis into a ground surface, instructing the student skier to change a direction of movement of the balance bike by engaging an edge of the rear ski of the balance bike into the ground surface, instructing the student skier to stand while straddling the frame, instructing the student skier to move in a forward direction while standing and straddling the frame, instructing the student skier to use the handlebars to change a direction of movement of the balance bike, and instructing the student skier to change a direction of movement of the balance bike by engaging an edge of the left and/or right skis into the ground surface.

In another embodiment, the balance bike may be removed.

In another embodiment, with the balance bike removed, the method may include demonstrating to the student skier at least one correlation between using the balance bike to change a direction of movement and using the left and/or right skis to change the direction of movement.

In another embodiment, with the balance bike removed, the method may include demonstrating to the student skier edging movements, rotary movements, and/or pressure movements.

In another embodiment, the left and/or right skis include left and/or right foot skis, respectively.

In another embodiment, the method may include removing the balance bike, removing the left and right foot skis, and securing a left standard-sized ski to the left foot of the student skier and securing a right standard-sized ski to the right foot of the student skier.

In another embodiment, with standard-sized skis secured to the student skier's left and right feet, the method may include demonstrating to the student skier at least one correlation between using the balance bike to change a direction of movement and using the left and right standard-sized skis to change the direction of movement.

In another embodiment, the method may include instructing the student skier to balance in the fore, aft, and/or lateral directions.

In another embodiment, the method may include demonstrating edging movements, rotary movements, and/or pressure movements.

In another embodiment, the method may include demonstrating edging movements, rotary movements, and/or pressure movements.

In another embodiment, the method may include demonstrating how an edge angle of the rear ski is gradually increased at the beginning of a ski turn, how the edge angle of the rear ski is increased to a highest angle at the apex of the ski turn, and how the edge angle of the rear ski is then decreased to the end of the turn.

In another embodiment, the method may include demonstrating how to direct pressure to an outside foot ski immediately before an edge of the outside foot ski is released from the ground surface at an initiation of a turn.

In another embodiment, the method may include demonstrating how to direct pressure to an outside foot ski immediately before an edge of the outside foot ski is released from the ground surface at an initiation of a turn.

According to another aspect, the present description includes a method of ski instruction. The method may utilize a balance bike equipped with a frame, at least one front ski, at least one rear ski, and a seat, and may comprise the steps of providing the balance bike to a student skier, securing a left ski to a left foot of the student skier and a right ski to a right foot of the student skier, instructing the student skier to sit on the seat and straddle the frame, demonstrating to the student skier how the rear ski is used to cause the balance bike to turn through edging movements and/or rotary movements, instructing the student skier to move in a forward direction while sitting on the seat and straddling the frame, instructing the student skier to use the handlebars to change a direction of movement of the balance bike, and instructing the student skier to change a direction of movement of the balance bike by engaging an edge of the rear ski of the balance bike into the ground surface.

In another embodiment, the method may include instructing the student skier to stand while straddling the frame, instructing the student skier to move in a forward direction while standing and straddling the frame, instructing the student skier to use the handlebars to change a direction of movement of the balance bike, and instructing the student skier to change a direction of movement of the balance bike by engaging an edge of the left and/or right skis into the ground surface.

In another embodiment, the method may include removing the balance bike, removing the left and right foot skis, and securing a left standard-sized ski to the left foot of the student skier and securing a right standard-sized ski to the right foot of the student skier.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows a stability assembly being used by a student skier as part of a ski instruction method according to exemplary embodiments hereof;

FIGS. 2A-2B show a stability assembly to be used by a student skier as part of a ski instruction method according to exemplary embodiments hereof;

FIG. 3 shows example steps of a ski instruction method according to exemplary embodiments hereof;

FIG. 4 shows example steps of a ski instruction method according to exemplary embodiments hereof;

FIG. 5 shows example steps of a ski instruction method according to exemplary embodiments hereof;

FIGS. 6A-6C show a stability assembly being used by a student skier as part of a ski instruction method according to exemplary embodiments hereof; and

FIGS. 7A-7C show a stability assembly being used by a student skier as part of a ski instruction method according to exemplary embodiments hereof.

### DETAILED DESCRIPTION OF EXEMPLARY EMBODIMENTS

As used herein, the term “ski instructor” or simply “instructor” will refer to any person or persons providing the presently disclosed ski instruction method to one or more student skiers or students. The term “student skier” or “student” will refer to any person receiving the ski instruction method.

As is known in the art, a student skier may better and more easily learn the fundamentals of skiing if the fear of injury is removed. Accordingly, the presently described ski instruction method accomplishes this by providing a stability assembly that may be used by the student skier to more easily maintain his/her fore, aft, and lateral balance while in motion, and to control his/her speed and direction of movement. The present method of the invention aims to teach alpine skiing by having the student utilize the presently disclosed apparatus to at least partially support his/her weight, to maintain fore/aft balance, to maintain lateral balance, to easily control speed, and/or to easily control direction of motion during the learning process.

Embodiments of the teaching method in utilizing the disclosed apparatus optimally reduce the physical and emotional learning barriers that a student must overcome to effectively learn to ski.

In general, and according to exemplary embodiments hereof, the ski instruction method described herein pertains to the use of a stability assembly during a ski instruction process. In some embodiments, the method includes using a stability assembly to support at least a portion of the student skier's weight while he/she learns how to ski. In some embodiments, the method includes using a stability assembly to assist in teaching the student skier fundamental edge, rotary, and pressure movements of skiing, individually and/or in combination.

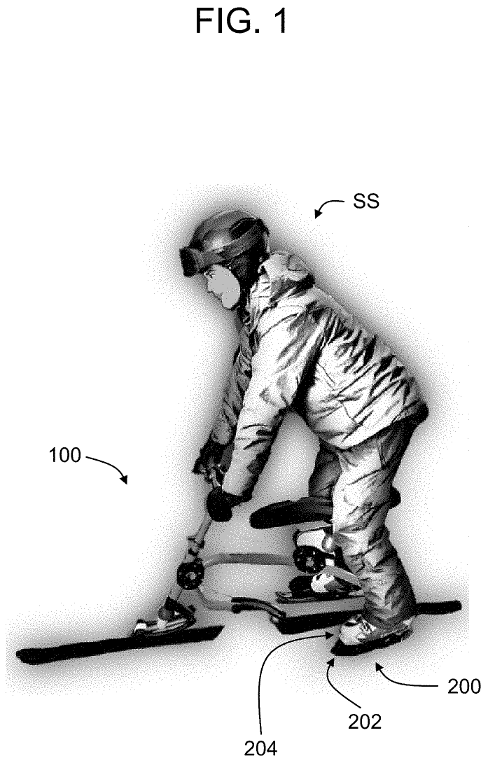

FIG. 1 shows a student skier SS utilizing a stability assembly 100 during a ski instruction process. For the purposes of this specification, the method will be primarily described as being used by a ski instructor to teach ski techniques to a student skier SS while on snow covered ground (e.g., on a ski mountain). However, it is understood that the instructional method may be used by anyone who may provide any types of ski instructions to one or more other persons. It also is understood that the method may be used by an individual to teach themselves the fundamentals of skiing.

In some embodiments, a student skier SS also may be equipped with ski equipment 200 in addition to the stability assembly 100 during the instructional method. However, this may not be required. The method also may include the use of other devices as described herein or otherwise.

In general, and as shown in FIG. 1, the stability assembly 100 may include a balance bike 102 and the ski equipment 200 may include foot skis 202, ski boots 204, and/or other equipment. This will be described in detail in other sections.

For the purpose of this specification, the term foot skis 202 will refer to skis that may be attached to a student skier's feet (either using ski boots and ski bindings or attachable directly to a shoe or boot using straps or other attachment mechanisms) and that range in length from about the size of the user's feet to about 70 cm. Skis with lengths greater or equal to about 70 cm may be referred to as standard-sized skis. It is understood that these lengths are general and are used for demonstration and that the actual length of a foot ski 202 and/or a standard-sized ski may vary. It also is understood that the scope of the method described herein is not limited in any way by the length of any type of ski used, whether it be a foot ski 202, a standard-sized ski, any other type(s) of skis and any combinations thereof.

In brief, the presently described method includes the following acts:
1. The student skier SS sits on the seat of the balance bike 102 while wearing left and right foot skis 202 placed on the ground to the left and right of the bike 102, respectively. This is a beginning step and keeps the student SS stable while enabling him/her to brake and turn. Fundamental edging movements may be taught during this step. Optionally, fundamental pressure movements also may be taught during this step.
2. The student stands up on the foot skis 202 (or on full length skis) and leans on the balance bike's handlebars for stability. The student SS is able to brake and turn at will. Fundamental pressure movements may be taught during this step. Optionally, edging movements may be further taught and/or reinforced during this step.
3. The stability assembly 100 is removed, and the student SS, in a standing position, is taught rotary movements. Edging and pressure movements also may be further taught and/or reinforced during this step.

Combinations of the acts may include using acts 1-3, acts 1 and 3, and/or acts 2 and 3. It is understood that the acts shown above are meant for demonstration and that further acts as well as further details of the acts will be described herein.

Stability Assembly 100

In general, the purpose of the stability assembly 100 is to provide stability and steadiness to a student skier SS during the ski instruction method described herein. In this way, the student skier SS may be less fearful during the instruction and may better practice and understand the lesson without fear of injury. Additionally, student skiers SS with physical limitations (e.g., strength, balance, and/or coordination limitations) may have less anxiety during the experience knowing that the ski method provides the physical support necessary to allow him/her to perform the exercises.

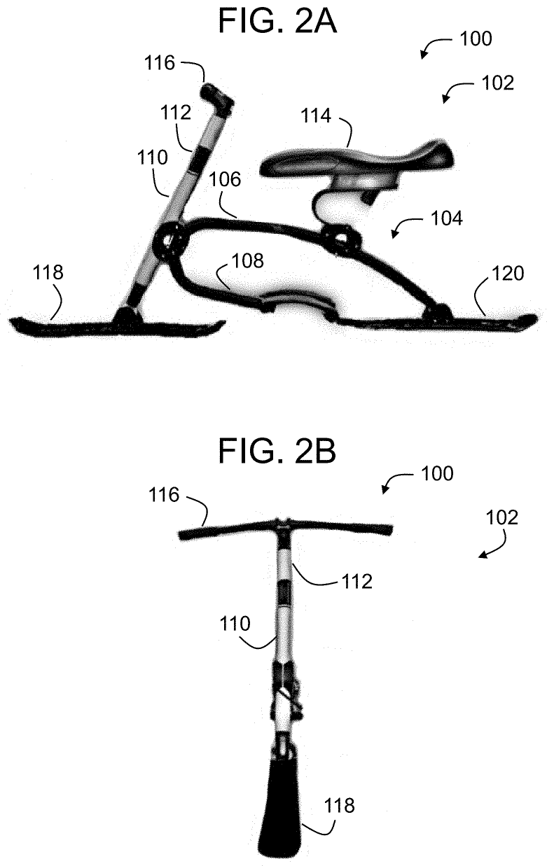

In some embodiments as shown in FIGS. 2A-2B, the stability assembly 100 includes a balance bike 102.

In some embodiments, the balance bike 102 includes a longitudinally oriented main frame 104 comprising a top tube 106, a down tube 108 and a head tube 110, a front steering column 112, a seat 114, handlebars 116, a front ski 118, and a rear ski 120. The balance bike 102 also may include other elements as required.

The front of the main frame 104 is connected to the head tube 110 that regulates independent rotation of a front steering column 112. The independent steering column 112 allows a user to partially support their weight onto the stability assembly 100 while being able to steer independently. In another embodiment (not shown), the main frame is connected to two head tubes, each connected to a separate steering column.

The rear end of the frame 104 is connected to a pivot joint, which is rigidly fixed to a rear ski 120, such that the rear ski 120 may passively rotate about the pivot joint independent to the main frame 104. The rear ski 120 provides a predominant avenue for most of the supported weight of the user to be transferred to the snow, liberating the front ski 118 to be utilized as the primary rotary driver. Furthermore, two sliding surfaces that are longitudinally distributed, such as a front 118 and rear ski 120, provide the user of the stability assembly 100 with fore/aft balance.

In another embodiment (not shown), the rear end of the main frame 104 is rigidly connected to the rear ski 120 such that the rear ski 120 is unable to laterally pivot about the attachment point to the main frame 104. Yet in another embodiment (not shown), the main frame 104 is connected to two laterally distributed skis that are connected mechanistically such that each ski can rotate independently of the other. In this embodiment, the skis are rigidly fixed to the main frame or can pivot about the lateral axis of the attachment point to the main frame. Two laterally distributed, mechanistically connected rear skis provide lateral balance during motion.

In some embodiments, the down tube 108 is mechanically connected to the front of the rear ski 120 so that the lateral rotation of the rear ski 120 is limited. In another embodiment (not shown), the rear ski is not connected to down tube, and the down tube is connected to the rear of the main frame.

In some embodiments, the front steering column 112 extends downwards from the head tube 110 through a front suspension system that connects to a front ski 118 via a pivot connection that allows the front ski 118 to rotate about the lateral axis at the attachment point to the steering column 112. In another embodiment (not shown), each front steering column does not include a front suspension system, and the steering column is connected directly to the ski via the pivot joint. The pivot joint connecting the front ski to the steering column ensures that the edges of the front ski follows the contour of the snow surface as the front steering column rotates.

In some embodiments, the steering column 112 extends upwards from the head tube 110 to rigidly attach to the handlebars 116 such that a user may control the rotation of the steering column 112 by applying a torque to the handlebars 116 about the steering column 112 to rotate the steering column 112 and the front ski 118. The handlebars 116 provide independent rotary control so that users can easily direct rotation of the stability assembly 100 about the steering column axis and about the longitudinal axis of the ski edges. This allows a user to simultaneously support their weight on the stability assembly 100, easily control direction of movement, and easily control “edging” movements (longitudinal rotary movements about the slope-side edge of the skis).

The main frame 104 is attached to the seat 114 via the seat attachment mechanism. The term “seat” refers to a structure that allows and is intended for a user to sit down on the stability assembly 100. The seat 114 provides a location for the user to sit down on the stability assembly 100, which minimizes the coordination requirements of the user's legs to direct motion down a ski slope and channels most of the user's weight through the stability assembly 100. Furthermore, in the seated position, the user can drive the rear edge of a set of small skis, referred to as “foot skis” (described below), into the snow to control his/her speed. In another embodiment (not shown) the stability assembly 100 does not include of a seat 114.

Ski Equipment 200

In some embodiments as shown in FIGS. 1, 6A-6C, and 7A-7C, the student skier SS may utilize ski equipment 200 during the disclosed ski instruction method. In some embodiments, the ski equipment 200 includes foot skis 202. As is known in the art, the foot skis 202 may be attached to the bottom of ski boots 204 worn by the student SS. In this way, because the foot skis 202 are secured to the student's feet, the foot skis 202 are able to move independent of the stability assembly 100.

In some embodiments, the foot skis are about 12″-20″ long, and the heel of the user's secured foot does not exceed beyond about 2″-5″ from the rear edge of the foot ski 202.

In some embodiments, the foot skis 202 provide the student skier SS with control of his/her own lateral stability when the sliding surface of the foot ski 202 rests on the snow surface. The foot skis 202 also provide the student SS with an easy means to control his/her speed as he/she may sit down on the stability assembly 100 and dig the rear edge of the foot skis 202 into the snow during motion to reduce speed. Releasing the rear foot ski edge from the snow increases speed when the stability assembly 100 is oriented down the slope.

In another embodiment (not shown), the student SS does not wear foot skis 202 on his/her feet but instead stands on the main frame of the stability assembly 100. In this case, it may be preferable that the stability assembly 100 include foot pegs. This embodiment is effective in providing lateral balance for the user if the stability assembly 100 has two connected rear skis (see the aforementioned embodiment that outlines two laterally distributed, connected rear skis).

In some embodiments, the foot skis 202 and/or the ski boots 204 are tethered to the stability assembly 100 using one or more flexible or rigid tethers. In some embodiments, the tethers are 6″-24″ long, and preferably about 12″-18″ long. In this way, the tethers may limit the lateral (outward) movement of the student's feet, ski boots 204, and foot skis 202.

The Method

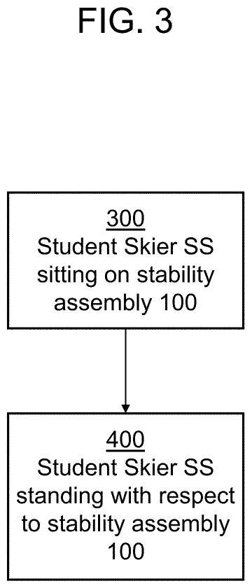

The presently disclosed ski instruction method will next be described in detail with reference to FIGS. 3, 4, 5, 6A-6C and 7A-7C.

In some embodiments, the ski instruction method teaches or otherwise provides guidance to a student skier regarding the fundamentals of skiing. For example, in some embodiments, the ski instruction method may teach the following elements of skiing (without limitation):
1. Standing on skis;
2. Keeping one's fore, aft, and lateral balance while on skis;
3. Learning how to start moving while skiing;
4. Learning how to stop moving while skiing;
5. Controlling one's speed while skiing;
6. Controlling one's direction while skiing (e.g., beginning a turn, executing a turn, completing a turn);
7. Using edge control;
8. Using ski rotation;
9. Using pressure control (e.g., fore/aft pressure, lateral pressure (foot-to-foo), pressure magnitude, etc.); and
10. Other actions to improve one's skiing abilities.

It is understood that the elements of skiing listed above are meant as examples of the different rudiments that the ski instruction method may provide, and that the ski instruction method may provide guidance on other elements of skiing, as necessary. It also is understood that the scope of the method is not limited in any way by the elements of skiing that it may teach.

In some embodiments, the ski instruction method may be performed while the student skier is generally stationary (e.g., not moving downhill), while in other embodiments the instruction method may be performed while the student skier is in motion (e.g., moving downhill). In preferred embodiments, the instruction method is performed during some segments of time while the student skier is generally stationary and during other segments of time while the student skier is in motion.

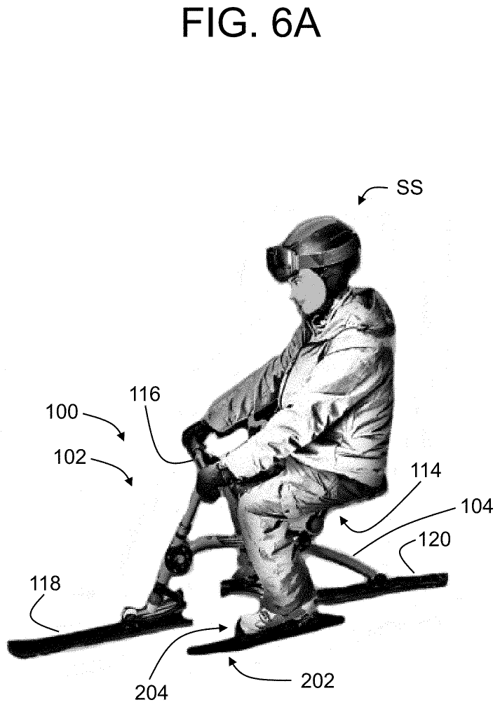

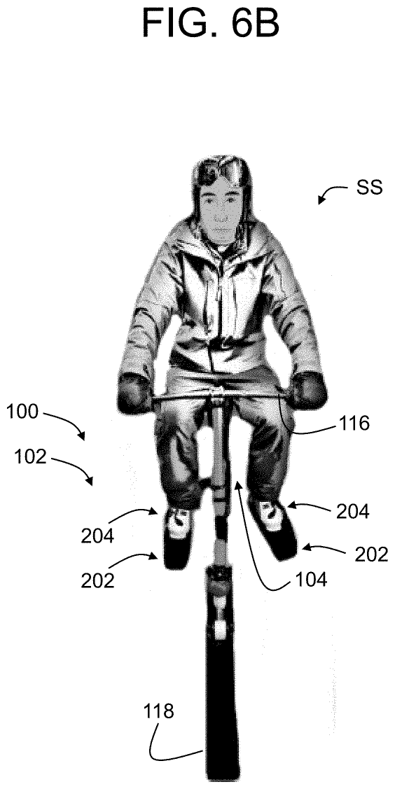

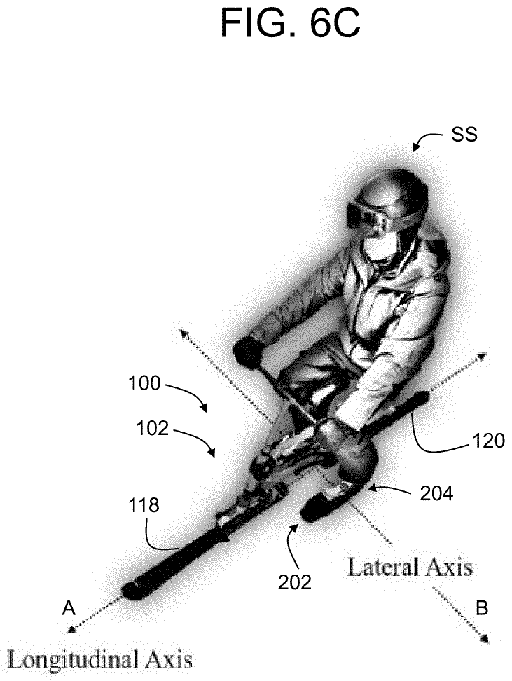

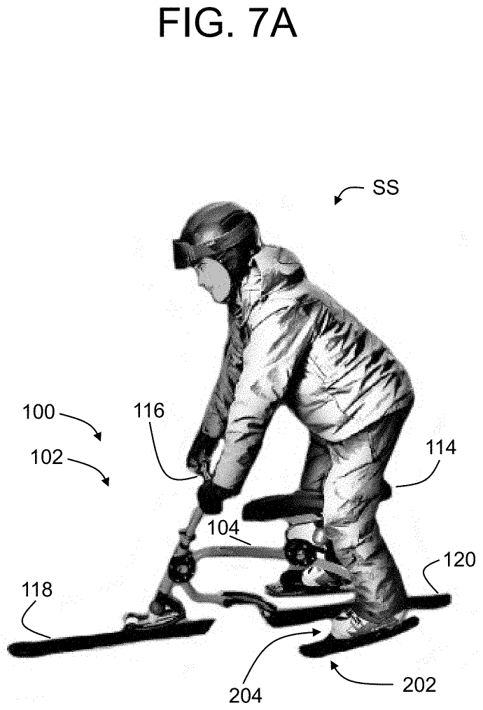

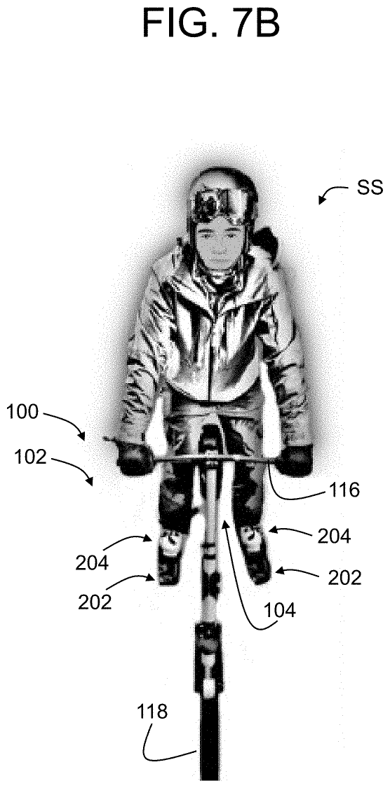

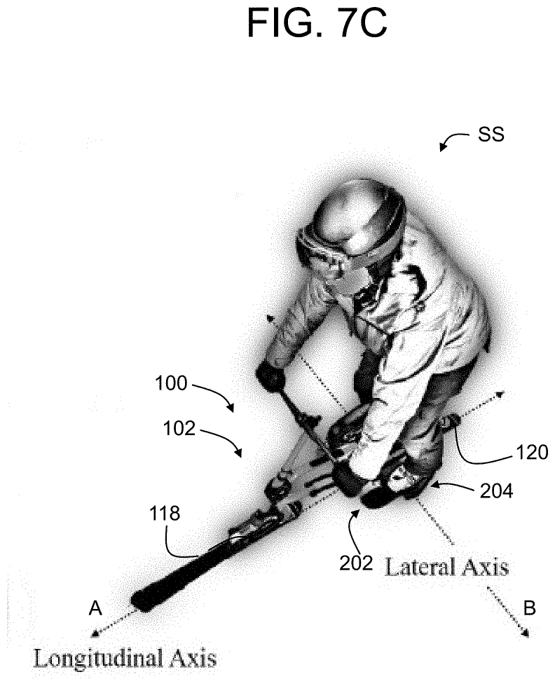

In some embodiments as shown in FIG. 3, instructional portion 300 of the ski instruction method is performed while the student skier SS is in a generally sitting position on the stability assembly 100 (see FIGS. 6A-6C), and instructional portion 400 of the ski instruction method is performed while the student skier SS is in a generally standing position with the stability assembly 100 (see FIGS. 7A-7C). In preferred embodiments, the ski instruction method is performed during some segments of time with the student skier SS sitting on the stability assembly 100 (portion 300) and during other segments of time with the student skier SS in a standing position with the stability assembly 100 (portion 400). In some embodiments, if the stability assembly 100 does not include a seat 114, all or portions of the instructional portion 300 may be removed and the ski instruction method may concentrate primarily on the instructional portion 400.

In some embodiments, the ski instruction method may begin with the student skier SS sitting on the stability assembly 100 (instructional portion 300) and may then progress to instructional guidance performed with the student skier SS in a standing position with the stability assembly 100 (instructional portion 400). It also is understood that portions 300 and 400 of the instruction method may be performed at any time during the instruction and/or in any sequence.

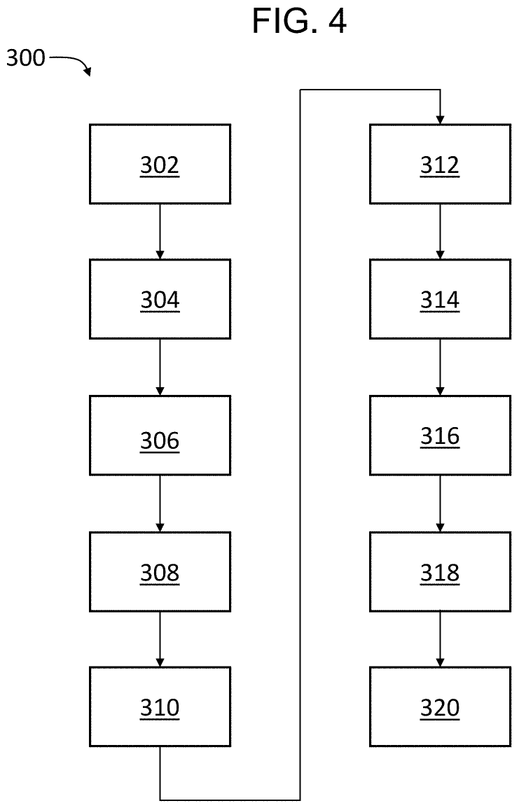

FIG. 4 refers to actions that may be taken to provide portion 300 of the ski instruction method. In one embodiment, at 302, the student skier SS is instructed to sit on the seat 114 of the stability assembly 100 with his/her hands on the handlebars 116, and with his/her feet resting on the ground on either side of the assembly 100. This is shown in FIGS. 6A-6C with FIG. 6A showing a side view of the student skier SS in a seated position with the stability assembly 100, FIG. 6B showing a front view of the student skier SS in a seated position with the stability assembly 100, and FIG. 6C showing a longitudinal axis A and a lateral axis B with respect to the student SS on the assembly 100. In this position, because the student skier SS is in a sitting position, most (if not all) of the student's weight may be directed through the stability assembly 100 to the ground.

Next (at 304) and while generally stationary, the student skier SS is instructed to practice balancing themselves in the fore, aft, and left/right lateral directions. This may include the student SS proportionally flexing his/her ankles, knees and hips to achieve balance all the while sitting on the stability assembly 100 and keeping his/her balance. This also may include leaning forward, backward, to the left, and to the right while sitting on the stability assembly 100.

Next (at 306), the ski instructor may explain and demonstrate how the rear ski 120 of the stabilizing assembly 100 may be positioned on the ground during a hypothetical ski turn (but while remaining stationary). During this instruction, the instructor guides the student skier SS to lean laterally to one side or the other (while still generally stationary) while watching how the outer edges of the assembly's rear ski 120 engage the ground with each lateral movement. This may include a demonstration on edge engagement as well as edge release.

Once the student skier SS understands how the edges of the assembly's rear ski 120 may engage and release from the snow surface (the ground), the instructor (at 308) may demonstrate how the assembly's rear ski 120 may be used to control the movement of the stability assembly 100 through edging movements, rotary movements, and/or the relationship between edging movements and rotary movements. This may include (at 310) guidance on how the edge angle of the rear ski 120 must be gradually increased at the beginning of a ski turn, how the edge angle must be increased to the highest angle at the apex of the ski turn, and how the edge angle then must be decreased to the end of the turn.

Next (at 312), the student skier SS, while still seated, is instructed to move the stability assembly 100 in a forward direction (in the direction of the longitudinal axis A of FIG. 6C). This may preferably be performed on a low grade downward slope so that the speed of the movement may be low and easily controllable.

Next (at 314), the student SS is instructed to use the handlebars 116 to slowly turn left or right, all the while focusing on the edges of the front ski 118 and/or of the rear ski 120 and how the edges of the ski(s) 118, 120 are engaged and/or released from the snow surface to turn the ski(s) 118, 120 (carving or brushed). This also may include instructing the student skier SS to engage the lateral inside edge of the front ski 118 by tipping the handlebars 116 to the inside of the turn.

At 316, the student SS is directed to place his/her foot skis 202 on the snow as if resting a hand palm-down on a table with minimal weight being directed to the foot skis 202 (except in times of instability). The student skier SS also may be directed to focus on the engagement of his/her foot skis with the ground, including the engagement of the foot ski edges and how the foot ski edges may track the edges of the front 118 and rear skis 120 of the stability assembly 100 during the turns.

Next (at 318), the student SS is instructed on how to slow down and/or stop by pushing the rear edges of his/her foot skis 202 into the snow (while in the seated position).

It is understood that the student skier SS may slow down and/or stop at any time during any portion 300, 400 of the ski instruction method, and that the student SS may then begin moving again as required by the instruction. However, it may be preferable that the student SS be instructed to only use the emergency braking method as described above as infrequently as possible and to instead use the techniques taught by the ski instruction method to control one's speed and to stop as necessary.

Next (at 320), the instructor may explain and demonstrate edging movements, rotary movements, pressure movements, the relationship between edging movements and rotary movements, the relationship between edging movements and pressure movements, the relationship between pressure movements and rotary movements, and/or the relationship between edging movements, rotary movements, and pressure movements in combination. This may include the instructor demonstrating how to actively direct pressure to the outside foot ski 202 just before the ski's edges are actively released from the snow at the initiation of a turn. Note that this may be performed with the student skier SS stationary and/or in motion.

It is understood that the actions described above with respect to instructional portion 300 are meant for demonstration and that the method may include other actions not listed. It also is understood that the method need not include all of the actions described, and that the actions may be performed in any order.

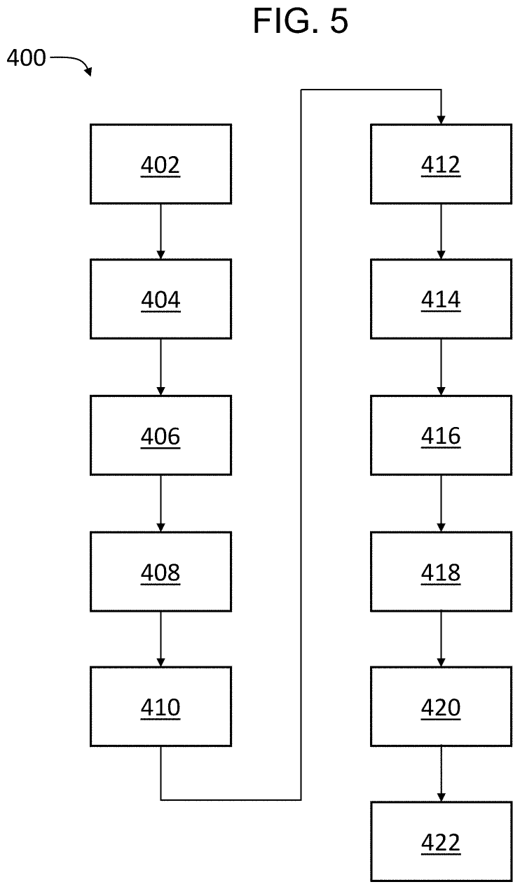

FIG. 5 refers to actions that may be taken to provide portion 400 of the ski instruction method. Portion 400 may preferably be performed after the student skier SS has mastered or at least generally understands the elements taught in portion 300.

In one embodiment, at 402, the student skier SS is instructed to stand on his/her foot skis 202 while straddling the main frame 104 of the stability assembly 100, and with his/her hands on the assembly's handlebars 116. In this way, even though the student SS may be in a standing position, he/she may direct a portion of his/her weight to the stability assembly 100 through the assembly's handlebars 116. In this position, the student also is able to control his/her rotation through use of the handlebars 116. This is shown in FIGS. 7A-7C with FIG. 7A showing a side view of the student skier SS in a standing position with the stability assembly 100, FIG. 7B showing a front view of the student skier SS in a standing position with the stability assembly 100, and FIG. 7C showing a longitudinal axis A and a lateral axis B with respect to the student SS with the assembly 100. In this standing position, the student SS may have more freedom to move and may rely on the stabilizer assembly 100 for support at his/her discretion when deemed necessary. Note that standard sized skis also may be used during this step.

Next (at 404) and while standing and still generally stationary, the student skier SS is instructed to practice balancing themselves in the fore, aft, and left/right lateral directions. This may include the student SS proportionally flexing his/her ankles, knees and hips to achieve balance all the while sitting on the stability assembly 100 and keeping his/her balance. This also may include leaning forward, backward, to the left, and to the right while standing and straddling the stability assembly 100 and keeping his/her balance.

Next (at 406), the ski instructor may explain and demonstrate how the rear ski GG of the stabilizing assembly 100 may be positioned on the ground during a ski turn. Even though this may have been described prior at 306, the student skier SS may benefit from this instruction again from the new perspective of the standing position. During this instruction, the instructor guides the student skier SS to lean laterally to one side or the other (while standing but still generally stationary) while watching how the outer edges of the assembly's rear ski 120 engage the ground with each lateral movement. During this step, because the student's skis 202 (or regular sized skis) are engaging the snow surface, the student may be instructed to focus on how the movement of his/her skis 202 may match the edge movements of the rear ski 120 during engagement and/or release of the skis 202, 120 from the snow.

Once the student skier SS understands how the edges of the assembly's rear ski 120 and how the edges of the student's foot skis 202 (or regular sized skis) may engage the ground, the instructor (at 408) may demonstrate how the assembly's rear ski 120 may be used to control the movement of the stability assembly 100 through edging movements, rotary movements, and/or the relationship between edging movements and rotary movements. This may include (at 410) guidance on how the edge angle of the rear ski 120 must be gradually increased at the beginning of a ski turn, how the edge angle must be increased to the highest angle at the apex of the ski turn, and how the edge angle then must be decreased to the end of the turn. Even though this may have been described prior at 310, the student skier SS may benefit from this instruction again from the new perspective of the standing position. During this step, the student SS also may be instructed on pressure movements, and how to direct pressure to his/her outside ski 202 throughout a turn and how to maintain fore/aft pressure to the skis 202.

Next (at 412), the student skier SS, while still standing, is instructed to move the stability assembly 100 in a forward direction (e.g., in the direction of the longitudinal axis A of FIG. 7C). This may preferably be performed on a low grade downward slope so that the speed of the movement may be low and easily controllable.

Next (at 414), the student SS is instructed to use the handlebars to slowly turn left or right, all the while focusing on the edges of the front ski 118 and/or of the rear ski 120 and how the edges of the ski(s) 118, 120 are engaged and/or released from the snow surface to turn the skis 118, 120 (carving or brushed). This also may include instructing the student skier SS to engage the lateral inside edge of the front ski 118 by tipping the handlebars 116 to the inside of the turn. During this step, the student SS also may be instructed on pressure movements, and how to direct pressure to his/her outside ski 202 throughout a turn and how to maintain fore/aft pressure to the skis 202.

At 416, the student SS is directed to focus on the engagement of his/her foot skis 202 with the ground, including the engagement of the ski edges and how the ski edges may track the edges of the front ski 118 and/or the edges of the rear ski 120 of the stability assembly 100 during the turns. Next (at 418), the student SS is instructed on how to slow down and/or stop by pushing the rear edges of his/her foot skis 202 into the snow (while in the seated position). The student also is instructed that that this action may require for the student SS to sit down on the seat of the stability assembly 100.

It is understood that the student skier SS may slow down and/or stop at any time during any portion 300, 400 of the ski instruction method, and that the student SS may then begin moving again as required by the instruction.

Next (at 420), the instructor may explain and demonstrate edging movements, rotary movements, pressure movements, the relationship between edging movements and rotary movements, the relationship between edging movements and pressure movements, the relationship between pressure movements and rotary movements, and/or the relationship between edging movements, rotary movements, and pressure movements in combination. This may include the instructor demonstrating how to actively direct pressure to the outside foot ski 202 just before the ski's edges are actively released from the snow at the initiation of a turn. Note that this may be performed with the student skier SS stationary and/or in motion. Even though this may have been described prior at 320, the student skier SS may benefit from this instruction again from the new perspective of the standing position.

It is understood that the actions described above with respect to instructional portion 400 are meant for demonstration and that the method may include other actions not listed. It also is understood that the method need not include all of the actions described, and that the actions may be performed in any order.

Because the intention of the invention is to teach a user how to ski on standard-sized skis, a next step (at 422) includes the instructor replacing use of the stability assembly 100 with using regular-sized (e.g., ˜140 cm long or longer) skis secured to the student's feet. In this step, the instructor explains and demonstrates how fundamental ski movements performed using the stability assembly 100 correlate to fundamental ski movements performed using regular-sized skis without the use of the assembly 100. Note that this step may be performed at any position in the sequence of steps 300 and/or 400.

While the present invention has been described as having particular configurations disclosed herein, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

It is understood that any aspect and/or element of any embodiment of the method(s) described herein or otherwise may be combined in any way to form additional embodiments of the method(s) all of which are within the scope of the method(s).

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A method of ski instruction using a balance bike, the method comprising:
(A) providing the balance bike to a student skier, the balance bike equipped with a frame, at least one front ski, at least one rear ski, and a seat;
(B) securing a left ski to a left foot of the student skier and a right ski to a right foot of the student skier;
(C) instructing the student skier to sit on the seat and straddle the frame;
(D) instructing the student skier to balance themselves on the balance bike;
(E) demonstrating to the student skier how the rear ski is used to cause the balance bike to turn through edging movements and/or rotary movements;
(F) instructing the student skier to move in a forward direction while sitting on the seat and straddling the frame;
(G) instructing the student skier to use the handlebars to change a direction of movement of the balance bike;
(H) instructing the student skier to slow down the speed of the balance bike by pressing a rear edge of the left and/or right skis into a ground surface;
(I) instructing the student skier to change a direction of movement of the balance bike by engaging an edge of the rear ski of the balance bike into the ground surface;
(J) instructing the student skier to stand while straddling the frame;
(K) instructing the student skier to move in a forward direction while standing and straddling the frame;
(L) instructing the student skier to use the handlebars to change a direction of movement of the balance bike; and
(M) instructing the student skier to change a direction of movement of the balance bike by engaging an edge of the left and/or right skis into the ground surface.

2. The method of claim 1 further comprising:
(N) removing the balance bike.

3. The method of claim 2 further comprising:
(O) demonstrating to the student skier at least one correlation between using the balance bike to change a direction of movement and using the left and/or right skis to change the direction of movement.

4. The method of claim 3 wherein the demonstrating in (0) includes demonstrating edging movements, rotary movements, and/or pressure movements.

5. The method of claim 1 wherein the left and/or right skis include left and/or right foot skis, respectively.

6. The method of claim 5 further comprising:
(N) removing the balance bike;
(O) removing the left and right foot skis; and
(P) securing a left standard-sized ski to the left foot of the student skier and securing a right standard-sized ski to the right foot of the student skier.

7. The method of claim 6 further comprising:
(Q) demonstrating to the student skier at least one correlation between using the balance bike to change a direction of movement and using the left and right standard-sized skis to change the direction of movement.

8. The method of claim 1 wherein the balancing instructed in (D) includes balancing in the fore, aft, and/or lateral directions.

9. The method of claim 1 wherein the demonstrating in (E) includes demonstrating edging movements, rotary movements, and/or pressure movements.

10. The method of claim 7 wherein the demonstrating in (Q) includes demonstrating edging movements, rotary movements, and/or pressure movements.

11. The method of claim 1 wherein the demonstrating in (E) includes demonstrating how an edge angle of the rear ski is gradually increased at the beginning of a ski turn, how the edge angle of the rear ski is increased to a highest angle at the apex of the ski turn, and how the edge angle of the rear ski is then decreased to the end of the turn.

12. The method of claim 3 wherein the demonstrating in (0) includes demonstrating how an edge angle of the rear ski is gradually increased at the beginning of a ski turn, how the edge angle of the rear ski is increased to a highest angle at the apex of the ski turn, and how the edge angle of the rear ski is then decreased to the end of the turn.

13. The method of claim 1 wherein the demonstrating in (E) includes demonstrating how to direct pressure to an outside foot ski immediately before an edge of the outside foot ski is released from the ground surface at an initiation of a turn.

14. The method of claim 3 wherein the demonstrating in (0) includes demonstrating how to direct pressure to an outside foot ski immediately before an edge of the outside foot ski is released from the ground surface at an initiation of a turn.

15. The method of claim 7 wherein the demonstrating in (Q) includes demonstrating how an edge angle of the rear ski is gradually increased at the beginning of a ski turn, how the edge angle of the rear ski is increased to a highest angle at the apex of the ski turn, and how the edge angle of the rear ski is then decreased to the end of the turn.

16. The method of claim 7 wherein the demonstrating in (Q) includes demonstrating how to direct pressure to an outside foot ski immediately before an edge of the outside foot ski is released from the ground surface at an initiation of a turn.

17. A method of ski instruction using a balance bike, the method comprising:
(A) providing the balance bike to a student skier, the balance bike equipped with a frame, at least one front ski, at least one rear ski, and a seat;
(B) securing a left ski to a left foot of the student skier and a right ski to a right foot of the student skier;
(C) instructing the student skier to sit on the seat and straddle the frame;
(D) demonstrating to the student skier how the rear ski is used to cause the balance bike to turn through edging movements and/or rotary movements;
(E) instructing the student skier to move in a forward direction while sitting on the seat and straddling the frame;
(F) instructing the student skier to use the handlebars to change a direction of movement of the balance bike;
(G) instructing the student skier to change a direction of movement of the balance bike by engaging an edge of the rear ski of the balance bike into the ground surface.

18. The method of claim 17 further comprising:
(H) instructing the student skier to stand while straddling the frame;
(I) instructing the student skier to move in a forward direction while standing and straddling the frame;
instructing the student skier to use the handlebars to change a direction of movement of the balance bike; and
(K) instructing the student skier to change a direction of movement of the balance bike by engaging an edge of the left and/or right skis into the ground surface.

19. The method of claim 1 further comprising:
(L) removing the balance bike.

20. The method of claim 5 further comprising:
(L) removing the balance bike;
(M) removing the left and right foot skis; and
(N) securing a left standard-sized ski to the left foot of the student skier and securing a right standard-sized ski to the right foot of the student skier.
